(19) United States
(12) Patent Application Publication
(10) Pub. No.: US 2023/0206327 A1
(43) Pub. Date: Jun. 29, 2023

(54) Computer Based Exchange Matching System and Method

(71) Applicant: Simon Thomas Heskett-Paoloni, London (GB)

(72) Inventor: Simon Thomas Heskett-Paoloni, London (GB)

(21) Appl. No.: 18/112,389

(22) Filed: Feb. 21, 2023

Related U.S. Application Data
(63) Continuation of application No. 14/288,611, filed on May 28, 2014.

(30) Foreign Application Priority Data
May 29, 2013 (GB) GB1309553.4

(51) Int. Cl. G06Q 40/04

(52) U.S. Cl. CPC G06Q 40/04

(57) ABSTRACT

There is provided a computer based system for arranging exchanges between individuals of a first group wishing to exchange a first type of items for a second type of items, and individuals of a second group wishing to exchange the second type of items for the first type of items. The system comprises a computer server with an offer interface for receiving offers from individuals of the first and second groups to exchange items at first exchange rates and second exchange rates, a display interface for outputting the offers for display, a request interface for receiving requests from the individuals of the first and second groups to make exchanges at the first exchange rates and second exchange rates, and a processor for confirming exchanges based on the requests and updating the offers that are sent for display based on the items remaining after each exchange.

### CROSS REFERENCE TO RELATED APPLICATIONS

This application claims the priority of UK Patent Application No. 1309553.4 filed May 29, 2013, which is incorporated herein by reference in its entirety.

### FIELD OF THE INVENTION

The present invention relates to computer based system and method of arranging exchanges of items between different individuals.

### BACKGROUND OF THE INVENTION

The Internet has enabled the electronic buying and selling of items such as financial goods and services and physical goods and services over computer networks, where buyers and sellers communicate directly with one another, without any need for independent agents to represent each of the parties.

For example, it is known to arrange the agreeing of exchange rates between buyer and seller quantities of currencies in foreign exchanges. The website having URL www.transferwise.com provides a peer-to-peer network allowing buyers and sellers of currency to be matched to one another at a mutually consenting exchange rate. For example, U.S. Pat. No. 7,194,481 discloses a computer based system and method designed to match parties and counterparties with one another in foreign exchanges, using a netting methodology to reduce the number and sizes of payment.

Various peer-to-peer networks are also known in the art for the exchange of other financial products at mutually consenting rates. For example, the website having URL www.lendingclub.com provides a peer-to-peer network allowing borrowers and lenders of currency to be matched to one another at a mutually consenting interest rate. An interest rate may be viewed as a type of exchange rate, in that the lender receives a percentage of the loan amount in exchange for providing the loan.

Such known methods of matching buyers and sellers to one another in computer based systems and methods typically require buyers and sellers to declare a price at which they wish sell or buy at, and then match buyers and sellers that declare the same price to one another. Therefore, each buyer and seller must each aim to declare a price at or near the current market rate in the hope of being matched to a corresponding seller or buyer to establish a deal.

Such methodologies are mainly focused toward cutting out the price differentials between buying and selling rates that are often set by agencies, and instead use a single rate at which each buyer buys and each corresponding seller sells, in order to provide better value to individuals. However, these methodologies normally provide only very limited information to buyers and sellers on the current state of the market.

Buyers and sellers may be asked to state an exchange rate at which they wish to deal at, and then await the market level to reach that exchange rate so that a deal can be established with a matching seller or buyer offering the same exchange rate. Commonly, buyers or sellers must refer to a current exchange rate—for example an exchange rate offered by a large institution or published by the peer-to-peer network—and declare acceptance of such exchange rate.

It is therefore desirable to provide an improved computer based system and method, which provides a better view of the market, and in which buyers and sellers can compete more effectively with one another based on the exchange rates that other buyers and sellers are declaring.

### SUMMARY OF THE INVENTION

According to an embodiment of the invention, there is provided a computer based system for arranging exchanges between individuals of a first group wishing to exchange a first type of items for a second type of items, and individuals of a second group wishing to exchange the second type of items for the first type of items. The system comprises a computer server for receiving offers and requests from the individuals of the groups, and the computer server comprises an offer interface for: receiving offers from individuals of the first group to exchange the first type of items for the second type of items at first exchange rates, each first exchange rate being a rate at which an individual of the first group offers the first type of items in return for the second type of items; receiving offers from individuals of the second group to exchange the second type of items for the first type of items at second exchange rates, each second exchange rate being a rate at which an individual of the second group offers the second type of items in return for the first type of items, an output interface for outputting the offers for display to both the first and second groups of individuals; a request interface for: receiving requests from individuals of the first group to exchange the first type of items for the second type of items at one of the second exchange rates currently offered by the individuals of the second group; receiving requests from individuals of the second group to exchange the second type of items for the first type of items at one of the first exchange rates currently offered by the individuals of the first group; and a processor for confirming exchanges based on the requests and updating the offers that are sent for display based on the items remaining after each exchange.

According to another embodiment of the invention, there is provided a method of arranging exchanges between individuals of a first group wishing to exchange a first type of items for a second type of items, and individuals of a second group wishing to exchange the second type of items for the first type of items. The method comprises: the first group of individuals offering to the second group of individuals a plurality of first exchange rates between the first type of items and the second type of items, each first exchange rate being a rate at which an individual of the first group offers the first type of items in return for the second type of items, each offer being made by an individual of the first group sending the offer to an offer interface of a computer server; the second group of individuals offering to the first group of individuals a plurality of second exchange rates between the first type of items and the second type of items, each second exchange rate being a rate at which an individual of the second group offers the second type of items in return for the first type of items, each offer being made by an individual of the second group sending the offer to the offer interface of the computer server; outputting the offers for display to both the first and second groups of individuals; receiving requests at a request interface of a computer server, the requests comprising requests from individuals of the first group to exchange the first type of items for the second type of items at one of the second exchange rates currently offered by the individuals of the second group, and requests from individuals of the second group to exchange the second type of items for the first type of items at one of the first exchange rates currently offered by the individuals of the first group; and confirming exchanges based on the requests and updating the offers that are sent for display based on the items remaining after each exchange.

In the exchange of a quantity of the first type of item held by an individual of the first group, for a quantity of the second type of item held by an individual of the second group, the individual of the first group may be considered as both a buyer of the second type of item and a seller of the first type of item. Furthermore, the individual of the second group may be considered as both a buyer of the first type of item and a seller of the second type of item. The first type of items may for example be goods or services, and the second type of items may be units of a monetary currency. Or, the first type of items may be units of a first monetary currency, and the second type of items may be units of a second monetary currency. The computer server may provide a virtual forum or arena for a direct connectivity and interactivity between the first and second groups (communities) of individuals.

The individuals participating in the exchanges may be natural or legal individuals, i.e. persons or companies. Individuals of the first group are considered to be counterparties to individuals of the second group, and individuals of the second group are considered to be counterparties to individuals of the first group. The exchange rate defines the amount of first items to be provided in return for the second type of item, or the amount of second items to be provided in return for the first item. For example, if the first type of items are potatoes and the second type of items are dollars of US currency, then the exchange rate may be a price specifying how many US dollars are to be paid in return for each pound of potatoes.

The computer server provides for direct connectivity and interactivity between the first and second groups of individuals, and may in effect implement a virtual forum or arena for arranging exchanges of first and second types of items between individuals of the first and second groups.

The provision of the request interface introduces a flexibility and freedom for individuals to select a counterparty exchange rate to agree an exchange at any time, regardless of their own exchange rate that they are currently offering. The selection of a counterparty exchange rate by an individual may cause the computer based system to match the quantity of the item required by the individual initiating the request against counterparty individual's quantities.

The request interface therefore provides the individual with a manual or executive capability in the exchange rate selection process, as opposed to known systems and methods in which there is no direct identification of the counterparty by individuals and which automatically initiate and execute the exchange on behalf of the individuals.

This flexibility and freedom to obtain an exchange rate at any time, regardless of an individuals' own exchange rate position within the market, whilst structuring and ordering the process by which the counterparty individual is selected on the basis of the various exchange rates currently offered by the counterparty individuals, introduces a pro-active executive capability for all individuals in the market to obtain a counterparty exchange rate at any time, without having to advance towards the existing market exchange rate. Thus, if an individual offers an exchange rate which is away from an existing market exchange rate, the individual does not have to wait for the market exchange rate to move in the direction of their offered exchange rate before an exchange may be arranged.

Advantageously, individuals congregated within respective first and second groups (communities) on the internet, computer network or any other public or private data network, may select a counterparty exchange rate, from divergent exchange rate positions and match their quantity or amounts lodged for sale or purchase against a single or multitude of counterparty individuals on a peer to peer basis at mutually consenting rates or prices. This ability to select a counterparty rate, inherently means that individuals do not have to be congregated around an existing exchange rate, or advance towards it, in order for exchanges to take place.

The arrangement of exchanges between parties and counterparties is not therefore generated as an automatic consequence of both parties being congregated at the most favourable existing common exchange rate to both parties, as in known systems and methods. The exchanges may instead be arranged as independent manual selections by individuals of their desired exchange rate, whereby the counterparty is selected on merit for having set their exchange rate correctly in the market, and before everyone else. So whilst it is up to an individual to determine their desired exchange rate by selecting the counterparty exchange rate, it is also up to the counterparty individual to determine which exchange rate they believe will be selected by the requesting individuals and to set their exchange rate accordingly in anticipation of this. The counterparty individual may set their exchange rate according to the current state of the market, or the anticipated state of the market in the future.

The outputting of the offers for display enables interaction between the party and counterparty (first and second groups) of individuals since each party (first group) can respond to the exchange rates offered by the counterparty (second group) by shifting their offered exchange rates toward the exchange rates offered by the party (first group).

The offer interface may categorise each offer to exchange the first type of items for the second type of items into one of a plurality of predefined first exchange rate bands, and may categorise each offer to exchange the second type of items for the first type of items into one of a plurality of predefined second exchange rate bands.

Therefore, individuals offering exchanges are congregated into exchange rate bands according to the exchange rates that they offer. The predefined exchange rate bands may be configured according to any desired parameter in the sector or market to which the first and second types of items relate, for the purposes of allowing counterparty individuals to request quantities at one of the exchange rate bands. The exchange rate bands may be used as the principal basis for subdividing each congregation of individuals within the first and second groups (communities).

Individuals may input by any electronic method or process the first type of items which they wish to sell in return for the second type of items, or the second type of items which they wish to sell in return for the first type of items, which serves to categorise them in either the first or second groups of individuals. Furthermore, individuals may input a desired exchange rate which serves to categorise them within one of the exchange rate bands. For example, the computer based system may further comprise a computer terminal for use by an individual, the computer terminal comprising a web browser that is connected to the website interface of the computer server via the Internet. The web browser may enable an individual of the first or second groups to make offers and requests to the offer interface and the request interface.

The computer server may provide forums or arenas for the exchange of various types of items, beyond just exchanges of the first and second types of items. Individuals may input the types and numbers of items which they wish to exchange. In the instance of currencies, they would input the currency and currency amount they wished to sell and the counterparty currency they wished to buy in exchange, which would serve to place them within a forum or arena reflecting the currency they wished to sell and the currency they wished to buy in exchange.

The offers may be output for display by outputting the exchange rate bands for display, and the exchange rate bands may provide the basis upon which the party and counterparty quantities may be agreed at their mutually consenting rates.

The computer based system may order the offers in the predefined first exchange rate bands into respective first queues, each successive offer in each predefined first exchange rate band being added to the end of the queue for that predefined first exchange rate band, and order the offers in the predefined second exchange rate bands into respective second queues, each successive offer at each predefined second exchange rate band being added to the end of the queue for that predefined second exchange rate band.

The length of each queue preferably corresponds to the overall number of items comprised in the offers in the queue. The number of items comprised in each offer may be specified in terms of the number of items that the offer offers for sale, or the number of items that the offer requires to be purchased. Specifically, each offer from individuals of the first group may comprise a first exchange number of items, the first exchange number of items being either the number of the first type of items offered for sale, or the number of the second type of items required for purchase. Furthermore, each offer from individuals of the second group may comprise a second exchange number of items, the second exchange number of items being either the number of the second type of items offered for sale, or the number of the first type of items required for purchase.

Each request from an individual of the first group may specify a particular one of the predefined second exchange rate bands currently offered by the individuals of the second group that should be used for the requested exchange, and each request from an individual of the second group may specify a particular one of the predefined first exchange rate bands currently offered by the individuals of the first group that should be used for the requested exchange. Alternatively, each request from individuals of the first group may simply specify that the most favourable second exchange rate currently offered by the individuals of the second group should be used for the requested exchange, and each request from individuals of the second group may simply specify that the most favourable first exchange rate currently offered by the individuals of the first group should be used for the requested exchange.

Advantageously, each request from an individual of the first group may specify a first requested exchange number of items, the first requested exchange number of items being either the number of the first type of items requested for sale or the number of the second type of items requested for purchase. The processor may deduct the first requested exchange number of items from the front of the queue for the predefined second exchange rate band that is specified by the request, allocate to the individual of the first group the number of the second type of items that corresponds to the first requested exchange number of items, and send a confirmation to the individual of the first group, to confirm the second type of items have been allocated to the individual of the first group from one or more individuals of the second group at the predefined second exchange rate band specified by the request. The processor may further reduce a number of the first type of items currently offered by the individual of the first group making the request, by the first requested exchange number of items.

Furthermore, each request from an individual of the second group may specify a second requested exchange number of items, the second requested exchange number of items being either the number of the second type of items requested for sale or the number of the first type of items requested for purchase, and the processor may be configured to deduct the second requested exchange number of items from the front of the queue for the predefined first exchange rate band that is specified by the request, allocate to the individual of the second group the number of the first type of items that corresponds to the second requested exchange number of items, and send a confirmation to the individual of the second group, to confirm the first type of items have been allocated to the individual of the second group from one or more individuals of the first group at the predefined second exchange rate band specified by the request. The processor may further reduce a number of the second type of items currently offered by the individual of the second group making the request, by the second requested exchange number of items.

The peer to peer process of arranging exchanges of quantities of items may be achieved by pre-structuring or ordering of individuals within their exchange rate bands on a ‘First in’ to their desired exchange rate band, for a ‘First out’ selection upon an exchange against that exchange rate band. Thus, whilst any individual, from within both first and second groups, may conduct the process of initiating an exchange of their quantities brought to market by making a request, the individuals offering within an exchange rate band that is selected for an exchange are rewarded for having placed themselves within the selected exchange rate band in a timely fashion.

These and other aspects will become apparent from the following description of the invention taken in conjunction with the following drawings, although variations and modifications may be effected without departing from the spirit and scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, which are not necessarily to scale, in which:

FIG. 1 shows a schematic diagram of a computer based system according to a first embodiment of the invention.

FIG. 2 shows a flow diagram of a method implemented on the computer based system of FIG. 1.

FIG. 3 shows a screen display of Buyer and Seller sections according to the first embodiment with example exchange rate band ranges showing example prices or rates.

FIG. 4 shows a screen display according to a second embodiment of the invention showing example currency seller/seller sections with example exchange rate bands ranges showing example currency rates.

FIG. 5 shows a schematic diagram of a screen display and a queue illustrating the sequential ordering on a ‘First in’ basis of Individuals within exchange rate bands and distribution of their quantity within an exchange rate band.

FIG. 6 shows a screen display according to a third embodiment of the invention and illustrates the process of an individual selecting a counterparty exchange rate band for a quantity matching process from a sequenced position from within their own exchange rate band.

FIG. 7 shows a schematic diagram of a screen display and queues according to a fourth embodiment of the invention and illustrating the process by which exchange rate bands allow the continuous and seamless matching of different quantities.

FIG. 8 shows a schematic diagram of a screen display and two queues according to a fifth embodiment of the invention.

FIG. 9 shows another schematic diagram of a screen display and two queues according to the fifth embodiment of the invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

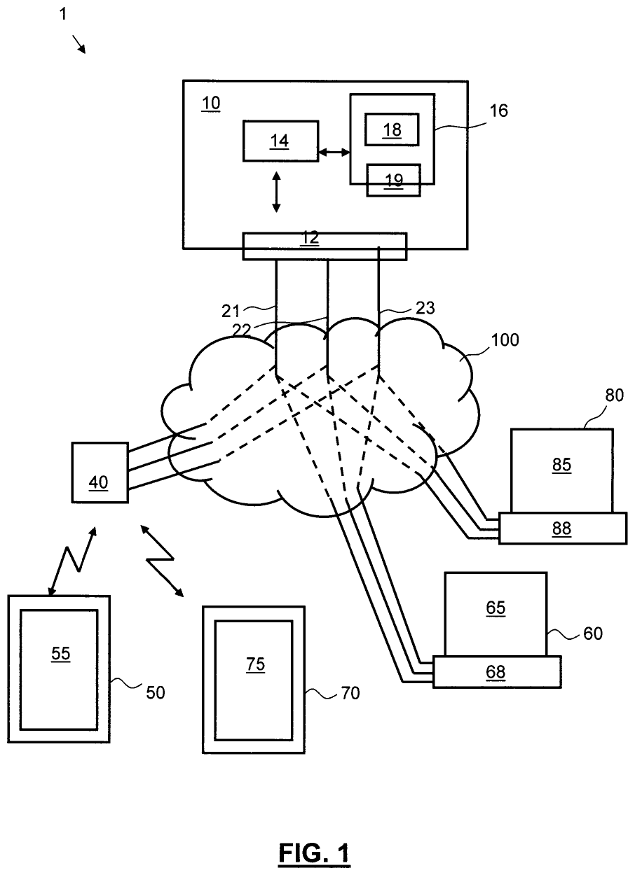

A first embodiment of the invention will now be described with reference to FIGS. 1, 2, and 3. FIG. 1 shows a schematic diagram of a computer based system 1 comprising a computer sever 10 and computer terminals 50, 60, 70, and 80. The computer server 10 is connected to each one of the computer terminals 50, 60, 70, and 80 via the Internet 100. The computer server 10 comprises a memory 16, a processor 14 connected to the memory 16, and a web interface 12 connected to the processor 14.

The memory 16 stores a website 18 and individual data 19. The website 18 is accessible via the web interface 12 of the computer server 10. The web interface 12 comprises an offer interface 21, a request interface 22, and an output interface 23, all of which are accessible by the computer terminals 50, 60, 70, and 80 via the Internet 100. The offer interface 21 is for receiving offers from the computer terminals 50, 60, 70, and 80, the request interface 22 is for receiving requests from the computer terminals 50, 60, 70, and 80, the output interface 23 is for outputting pages of the website 18 for display on the computer terminals 50, 60, 70, and 80. Clearly, the offer, request, and output interfaces are typically virtual interfaces rather than separate physical interfaces, and may be provided to the Internet 100 via one or more wired or wireless connections to the Internet 100.

The individual data 19 records data on each of the individuals that are registered to use the website 18, for example name and address details, finance or payment details. The individual data 19 also comprises an inventory for each respective individual registered to use the website 18, and the inventory holds information on the items that the individual currently possesses and which may be the subject of exchanges with other individuals conducted via the website 18.

In this embodiment, the computer terminals 50 and 70 are in the form of mobile telecommunications devices, which access the Internet via a mobile telecommunication base station 40. The mobile telecommunications devices 50 and 75 each have respective touchscreens 55 and 75, which can be used to enter and view information on the telecommunications devices. The computer terminals 60 and 80 are in the form of desktop computers, each having a respective base unit 68, 88 and a respective display screen 65, 85. However, other types of computing terminal could be used in alternate embodiments. Only four computer terminals are shown in FIG. 1, although in practice there may be hundreds, thousands or even millions of computing terminals all connecting to the website 18 of the computer server 10 via the internet 100.

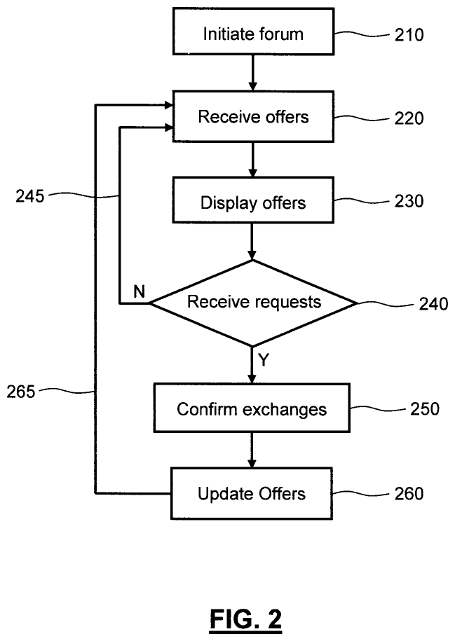

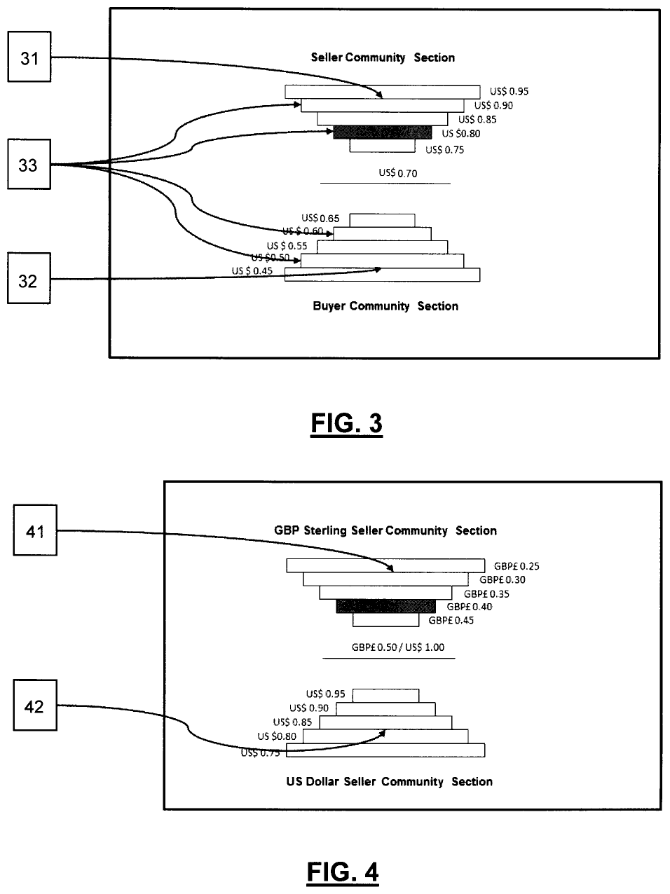

FIG. 2 shows a flow diagram of a method according to an embodiment of the invention, for implementation on the computer based system 1 of FIG. 1. In a first step 210, a forum is initiated within the website 18 for exchanging a first type of items with a second type of items. In this embodiment, the forum is initiated for exchanging pounds of potatoes (the first type of item), with dollars of US currency (the second type of item). The forum is further initiated to define the exchange rate as being the number of dollars to be exchanged for each pound of potatoes, and to define the width (range) of each exchange rate band as covering 5 cents (for example, refer to FIG. 3 showing exchange rate bands going up in 5 cent increments).

In a second step 220, the website forum is published on the Internet 100 via the web interface 12, and offers are invited from a first group (community) of individuals having potatoes and wishing to exchange them for dollars, and from a second group (community) of individuals having dollars and wishing to exchange them for potatoes. For convenience, in this embodiment the first group of individuals are referred to as sellers, and the second group of individuals are referred to as buyers. The sellers are registered on the website 18 and have potatoes recorded in their inventory stored in the data storage 19, and the buyers are also registered on the website 18 and have dollars recorded in their inventory stored in the data storage 19. Clearly, additional buyers or sellers may register on the website 18 at any time and record the items that they hold in an inventory in data storage 19.

The sellers operate computer terminals such as 50, 60, and access the website 18 via the Internet 100 using their computer terminals, to offer exchange rates (prices) at which they are prepared to sell potatoes for dollars. Furthermore, the buyers operate computer terminals such as 70, 80, and access the website 18 via the Internet 100 using their computer terminals, to offer exchange rates (prices) at which they are prepared to buy potatoes for dollars. The offers are received at the offer interface 21 of the web interface 12 of the computer server 10, and processed by the processor 14 for entry into the website 18.

The offers from the sellers each specify the number of pounds, of potatoes which the seller has to sell, and the offers from the buyers each specify the number of pounds of potatoes which the buyer wants to buy. The number of dollars which each seller wants to receive is implicitly specified in the seller's request by the number of pounds of potatoes and the exchange rate specified in the sellers request, and the number of dollars which each buyer wants to pay is implicitly specified in the buyer's request by the number of pounds of potatoes and the exchange rate specified in the buyer's request.

Alternatively, the sellers may simply specify in their offer a given number of dollars that they want in return for a given number of potatoes, making the exchange rate implicit to the seller's offer, and the buyers may simply specify in their offer a given number of pounds of potatoes that they want in return for a given number of dollars, making the exchange rate implicit to the buyer's offer.

The offers from the sellers are subdivided into a first set of exchange rate bands based on the exchange rate of each seller's offer, and the offers from the buyers are subdivided into a second set of exchange rate bands based on the exchange rate of each buyer's offer. Since sellers typically wish to sell at a higher exchange rate (higher price) than the market rate, and buyers typically wish to buy at a lower exchange rate (lower price) than the market rate, the first and second sets of exchange rate bands are spaced apart from one another with the current market rate somewhere in between the first and second sets of exchange rate bands. Optionally, the first and second sets of exchange rate bands may be prevented from overlapping one another by the offer interface 21 refusing offers from sellers having exchange rates lower than the highest exchange rate band with offers from buyers, and refusing offers from buyers having exchange rates higher than the lowest exchange rate band with offers from sellers.

In a third step 230, the offers are output for display on all the display screens of the computer terminals being used by individuals to access the forum on the website 18, such as display screens 55, 65, 75, and 85. FIG. 3 shows a view of one of the display screens, and it can be seen that the offers from the sellers are displayed in an upper portion 31 of each display screen by displaying the first set of exchange rate bands currently having offers from sellers, and that the offers from the buyers are displayed in a lower portion 32 of each display screen by displaying the second set of exchange rate bands currently having offers from buyers.

Each exchange rate band 33 is displayed as a rectangular graphical indicator. The length of the rectangular graphical indicator is set according to the total quantity of potatoes in the offers made by the sellers/buyers within the exchange rate band represented by the rectangular graphical indicator. In FIG. 3, it can been seen that the lengths of the graphical indicators are longer for seller exchange rate bands having higher exchange rates, since more potatoes are being offered for sale at higher exchange rates (prices) than at lower exchange rates (prices). It can also be seen that the lengths of the graphical indicators are longer for buyer exchange rate bands having lower exchange rates, since buyers are offering to buy more potatoes at lower exchange rates (prices) than at higher exchange rates (prices). Next to each graphical indicator is a numerical indication of the exchange rate which the graphical indicator represents.

The display of the exchange rate bands means that each buyer and seller can see what exchange rates other buyers and sellers are currently offering in the market, and make their own offers based on the current state of the market. For example, if a seller can see from the lengths of the first set of exchange rate bands at the portion 31 of the display screen that there are not many potatoes being offered by other sellers in relatively lower exchange rate bands, then the seller may be more inclined to make an offer for potatoes in a relatively higher exchange rate band in the hope that the supply of potatoes in the relatively lower exchange rate bands will soon be exhausted and that buyers will have to accept higher exchange rates (prices) if they wish to obtain potatoes. The identities of the various buyers and sellers corresponding to the offers may be published on the website 18, or the buyers and sellers may remain anonymous.

At step 240, the processor 14 awaits to receive requests from buyers or sellers to take up the offers that have been made by the buyers and sellers. Each party (seller or buyer) has the option of waiting until a counterparty (buyer or seller) makes a request to take up their offer, or the option of making a request to a counterparty to take up the counterparty's offer immediately. Any requests made are received at the request interface 22, and reviewed by the processor 14. If a request is made then the processor 14 moves to confirming the request at step 250, or if no request is received then the processor 12 returns 245 to awaiting further offers at the offer interface 21.

In this embodiment, the request interface 22 enables buyers to initiate a request by the buyer selecting the graphical indicator in the upper portion 1 of the display screen that corresponds to the exchange rate at which they wish to buy, and enables sellers to initiate a request by the seller selecting the graphical indicator in the lower portion 2 of the display screen that corresponds to the exchange rate at which they wish to sell. The selection may for example be made by the seller/buyer pressing the touchscreens 55 or 75 at the chosen exchange rate band, or by the seller/buyer positioning a mouse cursor over the chosen exchange rate band and clicking the mouse.

Buyers and sellers may base their decisions on whether to stick with their offer or whether to make a request based on a counterparty offer upon the state of the market as shown by the rectangular graphical indicators of the exchange rate bands. For example, if a buyer can see from the lengths of the rectangular graphical indicators that there are only a few pounds of potatoes left for sale at the lowest exchange rate band currently offered by sellers, then the buyer may choose to make a request at that exchange rate band immediately, rather than to risk relying on a seller requesting the buyer's own offer when the market exchange rate may be moving upwardly away from the buyer's offer.

Typically, a buyer will always select the lowest exchange rate band (price) currently offered by sellers when initiating a request, and a seller will always select the highest exchange rate band (price) currently offered by buyers when initiating a request, to provide the best value to the buyer or seller. Although, the buyer may select higher exchange rate bands if desired, or the seller may select lower exchange rate bands if desired. For example, this could be done if the buyer/seller wanted to sell/buy from a particular seller/buyer by virtue of the seller/buyer quantity or quality of items or reputation.

The rectangular graphical indicator representing the exchange rate band may also represent a queue of offers within that exchange rate band, the end of the queue (entry point) being to the left of the exchange rate band and the front of the queue (exit point) being to the right of the exchange rate band. New offers are always added to the end of the queue, and exchanges with counterparties requesting an exchange at a particular exchange rate band are always arranged with the counterparty(s) at the front of the queue. Thus, a party making an offer at a particular exchange rate band needs to wait until the previous offers made by other party(s) at that exchange rate band have all been taken up or removed, until their offer will form the basis for an exchange with a counterparty. Therefore, the first parties to make offers in a particular exchange rate band are rewarded by being the first parties to have their offers taken up by counterparties wishing to exchange at that exchange rate band.

Optionally, offers from different sellers in a single exchange rate band may be depicted by subdividing the rectangular graphical indicator representing the exchange rate band into portions corresponding to respective sellers, the length of each portion corresponding to the quantity of potatoes offered by the seller. If a buyer makes a request for more potatoes than are offered by the seller at the front of the queue, then the request may be fulfilled from the plurality of sellers at the front of the queue holding the required amount of potatoes.

Equivalently, offers from different buyers in a single exchange rate band may be depicted by subdividing the rectangular graphical indicator representing the exchange rate band into portions corresponding to respective buyers, the length of each portion corresponding to the quantity of potatoes desired by the seller. If a seller makes a request to sell more potatoes than are desired by the buyer at the front of the queue, then the request may be fulfilled by the plurality of buyers at the front of the queue that desire the amount of potatoes that the seller is requesting to sell.

Once a request has been made by a buyer to buy or a seller to sell a requested number of pounds of potatoes at a requested exchange rate band, the requested number of pounds of potatoes are deducted from the front of the queue for the requested exchange rate band, and allocated to the buyer. The inventory(s) of the seller(s) providing the requested number of pounds of potatoes are updated to reflect the reduction in the pounds of potatoes held by them.

Furthermore, a payment quantity of dollars is determined by the processor 14 based on the requested number of pounds of potatoes and the exchange rate of the requested exchange rate band, and the payment quantity of dollars is deducted from the inventory of the buyer and allocated to the inventory of the seller.

In the case where a seller makes an offer to sell potatoes using some or all of the potatoes currently recorded in their inventory, and then subsequently makes a request to sell potatoes to a buyer, in step 260 the amount of potatoes that the seller is offering to sell in their offer may be automatically reduced by the amount of potatoes that the seller has just sold by making the request. Furthermore, in the case where a buyer makes an offer to buy potatoes using some or all of the dollars currently recorded in their inventory, and then subsequently makes a request to buy potatoes from a seller, in step 260 the amount of potatoes that the buyer is offering to buy in their offer may be automatically reduced by the amount of potatoes that the seller has just bought by making the request. Therefore, all the quantities held by the buyer and seller which are included in the exchange are removed from the displayed offers. These reductions help to move new offers towards the front of the queue for whichever exchange rate band the offer relates to, thus helping to perpetuate the cycle of individuals advancing along the queues for the exchange rate bands.

Once the offers have been updated by removing the quantities involved in the exchange from the offers, the processor 14 loops back along path 265 to check for any new offers that may have been received.

The option for both sellers and buyers to make both offers and requests means that the arrangement of exchanges is very much a two way process in that both buyers and sellers (all parties) may contribute to the arrangement process by being able to select a counterparty exchange rate band for exchange. The requester in exchanges may be referred to as the initiator and the counterparties whose offers fulfil the request may be referred to as recipients. The initiators quantity is used for the exchange, at the recipient's exchange rate, wherein the recipients exchange rate is within the exchange rate band selected by the initiator.

As the quantity amount selected by the initiator is met from the recipient's exchange rate band, it is the case that the first recipient's quantity available for selection will either be more or less than the initiators quantity amount. If the recipient's quantity is more, then the amount equating to the initiators quantity is selected and removed from the recipient's quantity, with the recipients quantity truncated at the point corresponding to the initiators quantity. If the recipient's quantity is less, then the amount equating to the initiators quantity is selected from the quantities of the first recipient and the quantities of as many other recipients in the order in the queue as are required to make up the initiator quantity.

Accordingly, each initiator request is fulfilled by starting from the front (exit point) of the queue for the selected exchange rate band, and matching backwards through the queue, until enough recipient quantities to fulfil the initiators request are allocated to the initiator.

It will be appreciated that the first embodiment could be adapted for the sale of other types of physical commodities or financial products or services in return for monetary currency. The above embodiment can also be adapted for the exchanging of different monetary currencies wherein the first type of item is one type of monetary currency and the second type of item is another type of monetary currency, for example in the second embodiment as will now be described with reference to FIG. 4.

FIG. 4 shows a display screen laid out in a similar way to the display screen of FIG. 3, except for that the individuals of the first group 41 are individuals wishing to exchange sterling pounds in return for US dollars, and individuals of the second group 42 are individuals wishing to exchange US dollars in return for sterling pounds.

The exchange rate bands of the individuals of the first group step up in 5 penny increments, ranging from sellers that wish to buy dollars at 0.25 pounds each, to sellers that wish to buy dollars at 0.45 pounds each. The exchange rate bands of the individuals of the second group step up in 5 cent increments, ranging from sellers that wish to buy a number of 0.5 pounds at 0.75 dollars each, to sellers that wish to buy a number of 0.5 pounds at 0.95 dollars each. The exchange rate bands of the first and second groups are at opposite sides of the current market rate of 0.5 pounds per dollar.

Therefore, it can be seen that the exchange rates do not need to be labelled consistently across the first and second groups, but can be labelled in whichever way is most convenient for the individuals of the groups. Each exchange rate may be defined in terms of how many of the first type of items are equivalent to one of the second type of items, or in terms of how many of the second type of items are equivalent to one of the first type of items, whichever is the most convenient for the particular types of items being exchanged.

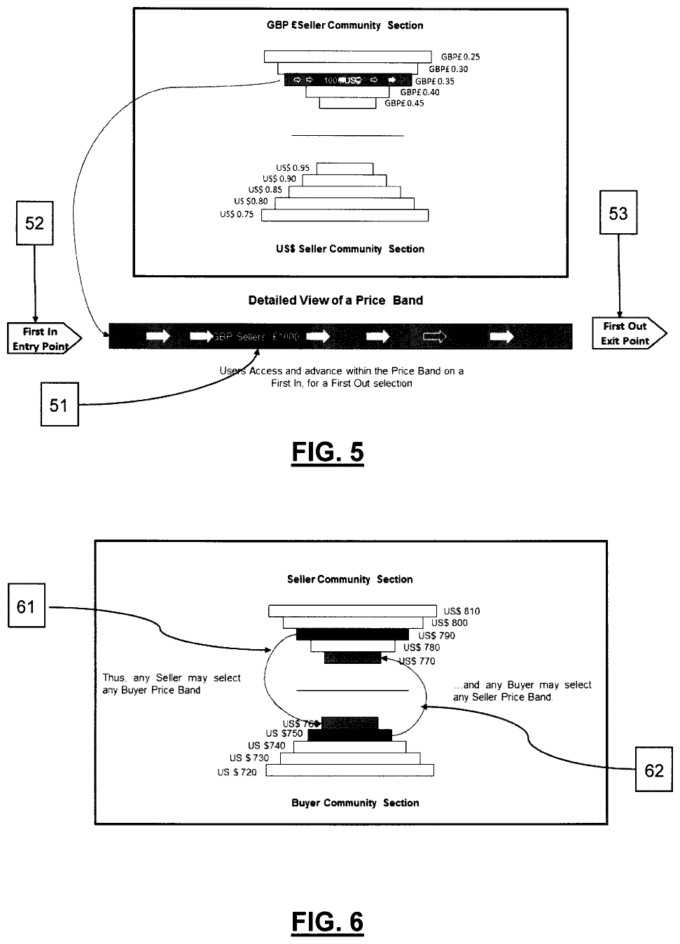

FIG. 5 shows a schematic diagram of the screen display of FIG. 4 and a queue illustrating the sequential ordering on a ‘First in’ basis of individuals within exchange rate bands, and distribution of their quantity within an exchange rate band. The illustrated queue 51 corresponds to the queue for the £0.35 exchange rate band of the individuals of the first group, and shows an entry point 52 to the queue where new offers to sell sterling within the £0.35 exchange rate band are added to the queue, and an exit point 53 where offers are utilised to fulfil requests from individuals of the second group to make exchanges at the £0.35 exchange rate band.

FIG. 6 shows a screen display according to a third embodiment of the invention. The third embodiment is just the same as the first and second embodiments, except for that units of financial stocks are being exchanged for US dollars by a individuals of a first group, and US dollars are being exchanged for units of financial stocks by individuals of a second group. Accordingly, the individuals of the first group may be referred to as sellers of stocks, and the individuals of the second group may be referred to as buyers of stocks. Both the exchange rate bands of the buyer and seller groups (communities) are arranged in $10 increments.

The arrow 61 designates a request from a seller of stocks. The seller has previously offered to sell stocks at $790 per unit, but has now decided to make the request 61 to take up a buyer's offer to buy stocks at $760 per unit. Accordingly, the seller decides to sell his stock units at $760 per unit immediately, instead of waiting around for a buyer to accept the seller's offer of selling stock units at $790 per unit.

The arrow 62 designates a request from a buyer of stocks. The buyer has previously offered to buy stocks at $750 per unit, but has now decided to make the request 62 to take up a seller's offer to sell stocks at $770 per unit. Accordingly, the buyer decides to buy stock units at $770 per unit immediately, instead of waiting around for a seller to accept the buyer's offer of buying stock units at $750 per unit.

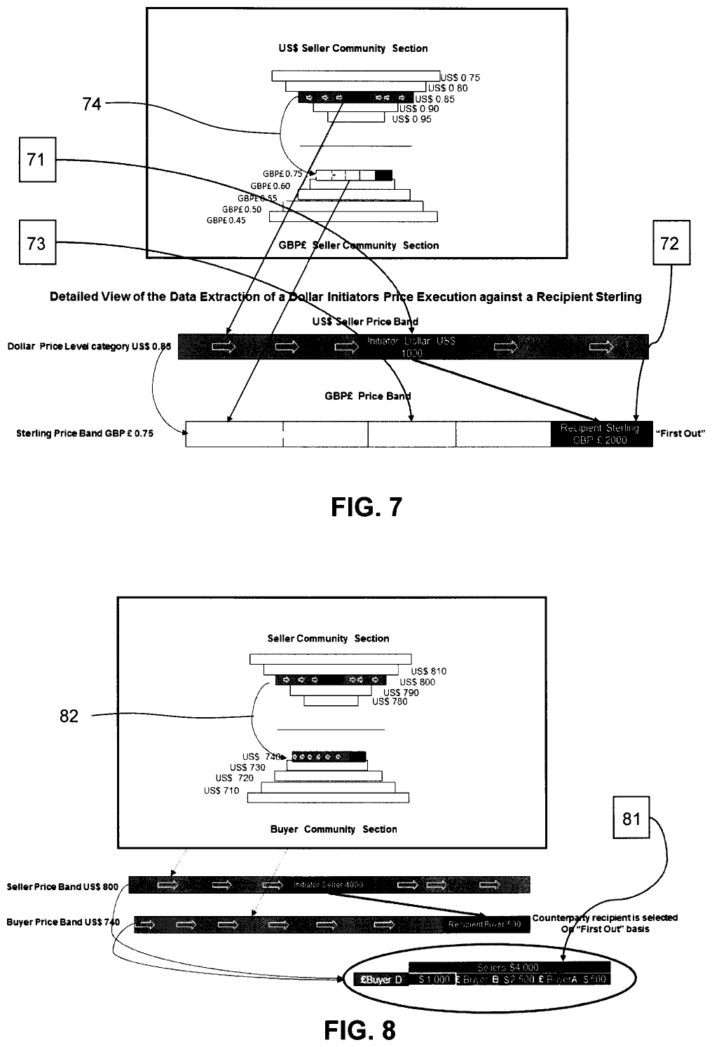

FIG. 7 shows a schematic diagram of a screen display and two queues according to a fourth embodiment of the invention. The fourth embodiment is just the same as the second embodiment, except for that the way in which the exchange rates are numerically expressed has been altered.

The arrow 74 designates a request from a seller of US dollars. The seller has previously offered to sell US dollars at 0.85 dollars per pound sterling, but has now decided to make the request 74 to accept offer(s) from seller(s) offering to sell 0.75 pounds sterling in return for each US dollar received. The seller of US dollars makes the request 74 to accept offer(s) of seller(s) of pounds sterling, and so the seller of US dollars is the initiator, and the seller(s) of pounds sterling are the recipient(s).

Although the initiator's own offer 71 in the $0.85 exchange rate band is only half way along the queue for the $0.85 exchange rate band, the initiator can still make the request to the recipient(s) to buy pounds sterling in return for US dollars. The recipients 72 who receive the request are those who are at the end of the queue 73 for the 0.75 pounds sterling exchange rate band, and therefore those who have been in the queue 73 the longest and made their offers the earliest.

Upon completion of the request 74, the initiator's own offer 71 in the $0.85 exchange rate band is removed from the exchange rate band, so that the more recent offers in the exchange rate band can advance towards the front of the queue.

FIG. 8 shows a schematic diagram of a screen display and two queues according to a fifth embodiment of the invention. The fifth embodiment is just the same as the third embodiment, except for that the exchange rate bands currently populated with offers from buyers and sellers are different to in the third embodiment.

The arrow 82 designates a request from a seller of stocks. The seller has previously offered to sell $4000 dollars worth of stocks at $800 per unit, but has now decided to make the request 82 to take up buyer offer(s) to buy stocks at $740 per unit. Accordingly, the seller decides to sell his $4000 dollars worth of stocks at $740 per unit immediately, instead of waiting around for a buyer to accept the seller's offer of selling stock units at $800 per unit. Clearly the seller's $4000 of stocks are worth slightly less than $4000 when valued at $740 rather than $800 per unit.

The request 82 is applied to the buyers whose offers are at the front of the queue for the $740 per unit exchange rate band, by matching the seller's stocks against the buyers offers from the very front (i.e. the exit point) of the queue towards the rear (entry point) of the queue until enough offers to buy stock to match the sellers request are allocated. As shown at 81, these offers from buyers comprise buyer A offering $500 of stock units, buyer B offering $2500 of stock units, and Buyer D offering more than $1000 of stock units. Since the seller is selling slightly less than $4000 of stocks, when the exchange is confirmed, the offers from buyers A and B are fully taken up, and buyer D's offer is reduced by almost $1000.

This exchange advances the other buyers in the queue for the $740 per unit exchange rate band towards the front of the queue. Furthermore, the sellers offer to sell his $4000 of stocks at $800 per unit is removed from the $800 per unit exchange rate band.

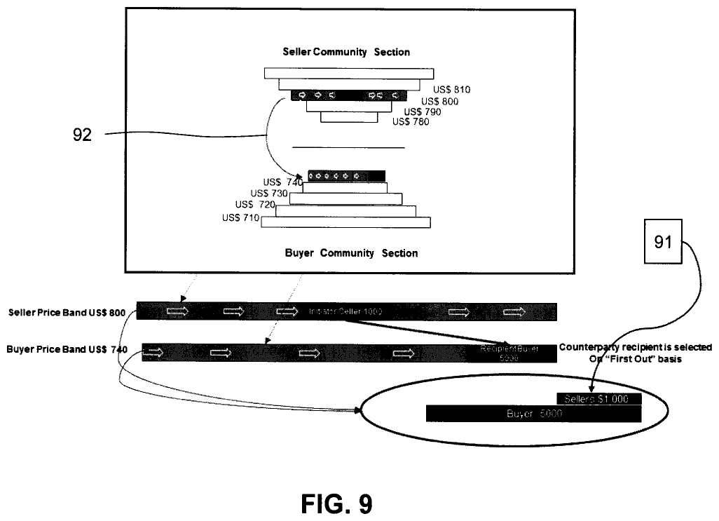

FIG. 9 shows another schematic diagram of a screen display and two queues according to the fifth embodiment of the invention.

The arrow 92 designates a request from a seller of stocks. The seller has previously offered to sell $1000 dollars worth of stocks at $800 per unit, but has now decided to make the request 92 to take up a buyer's offer to buy stocks at $740 per unit. Accordingly, the seller decides to sell his $1000 dollars worth of stocks at $740 per unit immediately, instead of waiting around for a buyer to accept the seller's offer of selling stock units at $800 per unit. Clearly the seller's $1000 of stocks are worth slightly less than $1000 when valued at $740 rather than $800 per unit.

The request 92 is applied to the buyer whose offer is at the front of the queue for the $740 per unit exchange rate band. As shown at 91, this buyer is currently offering to buy $5000 worth of stocks at $740 per unit. Since the seller is only selling slightly less than $1000 of stocks, when the exchange is confirmed, slightly less than $1000 of stocks are deducted from the buyers offer, reducing the buyers remaining offer to just over $4000 worth of stocks. This advances the other buyers in the queue for the $740 per unit exchange rate band towards the front of the queue. Furthermore, the sellers offer to sell his $1000 of stocks at $800 per unit is removed from the $800 per unit exchange rate band.

The confirmed exchanges also allow for a real-time and on-going rate or price, referred to as a market rate, to be generated from the confirmed exchanges. The computer server may collate the rates of all the exchanges as they are conducted on a sequenced and temporal basis. For example, the confirmed exchanges may be used to gather data on the exchange rates used for each confirmed exchange, and these exchange rates may be collated either on a sequenced cumulative basis or on an intertemporal aggregation basis. These two options may further be weighted statistically by the quantity or amounts involved in the matching processes.

It is generally anticipated that the cumulative method would be used in smaller markets or sectors where the volume of individuals and hence matching processes would be small enough for each new exchange rate confirmed to impact on market rate.

It is generally anticipated that the inter-temporal method would be used in markets or sectors of high liquidity and volume in which individual exchange rates would have no reflective impact on the market, and thus rates or prices generated would have to be collated within pre-determined inter-temporal timeslots either cumulatively or according to a specified volume or frequency of rate or price generated, and then subsequently reflected as the last up to date market rate or price.

It will be understood that the specific embodiments of the present invention shown and described herein are exemplary only. Numerous variations, changes, substitutions and equivalents will now occur to those skilled in the art without departing from the spirit and scope of the invention. For example, the use of inventories helps buyers and sellers to keep track of the items which they are buying and/or selling, although there is no requirement for the computer server 10 to maintain inventories. For example, the computer server 10 could simply send exchange confirmation letters or emails to the buyer(s) and sellers(s) involved in each exchange, detailing the items involved in the exchange, without actually adding or subtracting items from inventories. Similarly, the use of rectangular graphical indicators is only one way in which the offers made by sellers and buyers can be displayed to individuals, and other ways are also contemplated within the scope of the invention. For example, the offers could be displayed as purely numerical data, or other shapes and types of graphical indicator could be used to represent the offers. Accordingly, it is intended that all subject matter described herein and shown in the accompanying drawings be regarded as illustrative only, and not in a limiting sense, and that the scope of the invention will be solely determined by the appended claims.

1-31. (canceled)

32. A method for improving a user experience and process efficiency in purchasing, selling, or trading fungible financial assets, by presenting a graphic user interface providing visual information to discern both overall market evolution trends and granular insight into individual offers, the method utilizing direct connectivity and interactivity between a user device and a community of other user devices, the method comprising:
categorizing an offer from a user into one of a plurality of predefined price or exchange rate bands, the offer comprising an identification of the fungible financial asset and a proposed price or exchange rate;
graphically presenting the offer from a user, allowing the offer to be individually identified as it enters a queue in the categorized band, such that a user may observe and determine velocities of sequencing within the price or exchange rate band;
graphically presenting other offers from other users in the same predefined price or exchange rate bands, such that a user may observe and/or determine velocities of sequencing of different prices or exchange rates;
graphically presenting the offer to the user;
receiving and graphically presenting offers from other user devices in the community, providing the user with actionable information to accept or further modify the offer;
while maintaining the first offer, modifying the offer from the user with a new price or exchange rate resulting in a modified offer.

33. The method of claim 32, further comprising:
receiving acceptance of the modified offer from a second user device and conducting a transaction comprising the accepted modified offer.

34. The method of claim 32, wherein the offers categorized in a first predefined price or exchange rate band are ordered into first queues, each subsequent offer in each predefined first price or exchange rate band being added to the end of the first queue.

35. The method of claim 34, wherein each offer in each predefined price or exchange rate band is displayed as a portion of a graphical indicator that corresponds to the predefined first price or exchange rate band, the graphical indicator corresponding to different positions within the queues, thereby allowing progression of the individual offers along the queues to be viewed on a display.

36. The method of claim 32, wherein the first price or exchange rates are prices at which individuals of a first group offer to sell units of a first monetary currency in return for units of a second monetary currency.

37. The method of claim 32, wherein the offers are monetary currency for goods or services, and wherein the price or exchange rate is a price at which the first user offers to sell the goods or services.

38. The method of claim 33, wherein the accepted modified offer is the price or exchange rate at which the second user agrees to purchase the goods or services.

39. The method of claim 32, wherein graphically presenting the offers comprises providing a user device with a graphic interface information to display.

40. The method of claim 39, wherein the user device receives the information to display via the Internet.

41. The method of claim 39, wherein graphically presenting an offer comprises displaying a numerical indicator of the predefined price or exchange rate band, the numerical indicator associated with an overall number of offers at the predefined price or exchange rate band.

42. The method of claim 33, wherein receiving acceptance of the modified offer comprises receiving an input from a second user selecting a graphic indicator of the modified offer on the second user device.

43. The method of claim 32, wherein the offer specifies a first price, exchange rate, or number of items for sale or exchange, and wherein the modified offer specifies a second price, exchange rate, or number of items for sale or exchange.

44. The method of claim 33, further comprising:
after acceptance of the modified offer, deleting the offer from the queue in the categorized band.
